(19) United States
(12) Patent Application Publication
(10) Pub. No.: US 2014/0111335 A1
(43) Pub. Date: Apr. 24, 2014

(54) METHODS AND SYSTEMS FOR PROVIDING AUDITORY MESSAGES FOR MEDICAL DEVICES

(71) Applicant: GENERAL ELECTRIC COMPANY, Schenectady, NY (US)

(72) Inventors: James Alan Kleiss, Oconomowoc, WI (US); Emil Markov Georgiev, Hartland, WI (US); Scott William Robinson, Bayside, WI (US)

(73) Assignee: General Electric Company, Schenectady, NY (US)

(21) Appl. No.: 13/656,316

(22) Filed: Oct. 19, 2012

(51) Int. Cl. G08B 21/18

(52) U.S. Cl. CPC G08B 21/18
USPC 340/540

(57) ABSTRACT

Methods and systems for providing auditory messages for medical devices are provided. One system includes at least one medical device configured to generate a plurality of medical messages and a processor in the at least one medical device configured to generate an auditory signal corresponding to one of the plurality of medical messages. The auditory signal is configured based on a functional relationship linking psychological sound perceptions in a clinical environment to acoustic and musical sound variables.

### BACKGROUND OF THE INVENTION

The subject matter disclosed herein relates generally to audible messages, and more particularly to methods and systems for providing audible notifications for medical devices.

In medical environments, especially complex medical environments where multiple patients may be monitored for multiple medical conditions, standardization of alarms and/or warnings creates significant potential for confusion and inefficiency on the part of users (e.g., clinicians or patients) in responding to specific messages. For example, it is sometimes difficult for clinicians and/or users of medical devices to distinguish or quickly identify the source and condition of a particular audible alarm or warning. Accordingly, the effectiveness and efficiency with which users respond to medical messaging can be adversely affected, which can lead to delays to responding to medical or system conditions associated with these audible alarms or warnings.

In particular, medical facilities typically include rooms to enable surgery to be performed on a patient, to enable a patient's medical condition to be monitored, and/or to enable a patient to be diagnosed. At least some of these rooms include multiple medical devices that enable the clinician to perform different types of operations, monitoring, and/or diagnosis. During operation of these medical devices, at least some of the devices are configured to emit audible indications, such as audible alarms and/or warnings that are utilized to inform the clinician of a medical condition being monitored. For example, a heart monitor and a ventilator may be attached to a patient. When a medical condition arises, such as low heart rate or low respiration rate, the heart monitor or ventilator emits an audible indication that alerts and prompts the clinician to perform some action.

Under certain conditions or in certain medical environments, multiple medical devices may concurrently generate audible indications. In some instances, two different medical devices may generate the same audible indication or an indistinguishably similar audible indication. For example, the heart monitor and the ventilator may both generate a similar high-frequency sound when an urgent condition is detected with the patient, which is output as the audible indication. Therefore, under certain conditions, the clinician may not be able to distinguish whether the alarm condition is being generated by the heart monitor or the ventilator. In this case, the clinician visually observes each medical device to determine which medical device is generating the audible indication. Moreover, when three, four, or more medical devices are being utilized, it is often difficult for the clinician to easily determine which medical device is currently generating the audible indication. Thus, delay in taking action may result from the inability to distinguish the audible indications from the different devices. Additionally, in some instances the clinician is not able to associate the audible indication with a specific condition and accordingly must visually view the medical device to assess a course of action.

Thus, in typical clinical settings, there is a lack of inherent meaning of medical messages in the auditory environment. Accordingly, the meanings need to be learned, which can result in the lack of a timely response, particularly with a novice clinical user, potentially causing adverse consequences to patients. There is also a lack of a meaningful relationship between the physical properties of auditory device signals and the intended messages, which can result in a lack of perceptual discrimination among various auditory signals.

Moreover, in some instances, no alarms and/or warnings exist for certain conditions, which can result in adverse results, such as injury to patients. For example, movement of major parts of medical equipment (e.g., CT/MR table and cradle, interventional system table/C-arm, etc.) is known for creating a potential for pinch points and collisions. In the majority of these cases, the only indication for these movements, especially for users not controlling the movements and for the patients, is direct visual contact, which is not always possible.

### SUMMARY OF THE INVENTION

In one embodiment, a medical system is provided that includes at least one medical device configured to generate a plurality of medical messages and a processor in the at least one medical device configured to generate an auditory signal corresponding to one of the plurality of medical messages. The auditory signal is configured based on a functional relationship linking psychological sound perceptions in a clinical environment to acoustic and musical sound variables.

In another embodiment, a method for providing a medical sound environment is provided. The method includes defining a plurality of auditory states representing a plurality of different medical messages or conditions and detecting one or more medical events and correlating the medical event to one of the medical messages or conditions. The method also includes triggering a medical auditory message corresponding to the detected medical event, wherein the medical auditory message is configured based on a functional relationship linking psychological sound perceptions in a clinical environment to acoustic and musical sound variables. The method further includes outputting audibly the medical auditory message corresponding to the detected medical event.

### BRIEF DESCRIPTION OF THE DRAWINGS

FIG. 1 is a block diagram illustrating a sounds environment in accordance with various embodiments.

FIG. 2 is a block diagram of an exemplary auditory device signal and/or medical message process flow in accordance with various embodiments.

FIG. 3 is a flowchart of a method for use in generating auditory device signals and/or medical messages in accordance with various embodiments.

FIG. 4 is an exemplary graph illustrating a cluster analysis performed in accordance with various embodiments.

FIG. 5 is an exemplary dendrogram in accordance with various embodiments.

FIG. 6 is an exemplary table illustrating factor loading values for bipolar attribute pairs in accordance with an embodiment.

FIG. 7 is an exemplary scatter plot in accordance with an embodiment.

FIG. 8 is another exemplary scatter plot in accordance with an embodiment.

FIG. 9 is an exemplary table of values predicted by one or more regression models in accordance with various embodiments.

FIG. 10 is an exemplary table illustrating target values for defining auditory signals in accordance with various embodiments.

FIG. 11 is another exemplary table illustrating a range of values for defining auditory signals in accordance with various embodiments.

FIG. 12 is block diagram of an exemplary medical facility in accordance with various embodiments.

FIG. 13 is a block diagram of an exemplary medical device in accordance with various embodiments.

### DETAILED DESCRIPTION OF THE INVENTION

The following detailed description of certain embodiments will be better understood when read in conjunction with the appended drawings. The figures illustrate diagrams of the functional blocks of various embodiments. The functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, or the like) or multiple pieces of hardware. Similarly, the programs may be stand alone programs, may be incorporated as subroutines in an operating system, may be functions in an installed software package, and the like. It should be understood that the various embodiments are not limited to the arrangements and instrumentality shown in the drawings.

Various embodiments provide methods and systems for providing audible or auditory indications or messages, particularly audible alarms and warnings for devices, especially medical devices. The various embodiments provide methods and systems for the management of an auditory messaging environment in clinical settings. For example, a classification system may be provided, as well as a semantic mapping for these audible indications or messages to manage the perceptual discrimination among various auditory signals.

At least one technical effect of various embodiments is improved effectiveness and efficiency for clinicians responding to medical conditions in clinical settings. Some embodiments also allow for continuous feedback on the degree to which a patient's condition is within a healthy range. Additionally, various embodiments allow for designing unique soundscapes for medical environments.

As described in more detail herein, the various embodiments provide for the differentiation of audible notifications or messages, such as alarms or warnings based on acoustical and/or musical properties that convey specific semantic character(s). Additionally, these audible notifications or messages also may be used to provide an auditory means to indicate device movements, such as movement of major equipment pieces. It should be noted that although the various embodiments are described in connection with medical systems having particular medical devices, the various embodiments may be implemented in connection with medical systems having different devices or non-medical systems. The various embodiments may be implemented generally in any environment or in any application to distinguish between different audible indications or messages associated or corresponding to a particular event or condition for a device or process.

As used herein, an audible or auditory indication or message refers to any sound that may be generated and emitted by a machine or device. For example, audible indications or alarms may include auditory alarms or warnings that are specified in terms of frequency, duration and/or volume of sound.

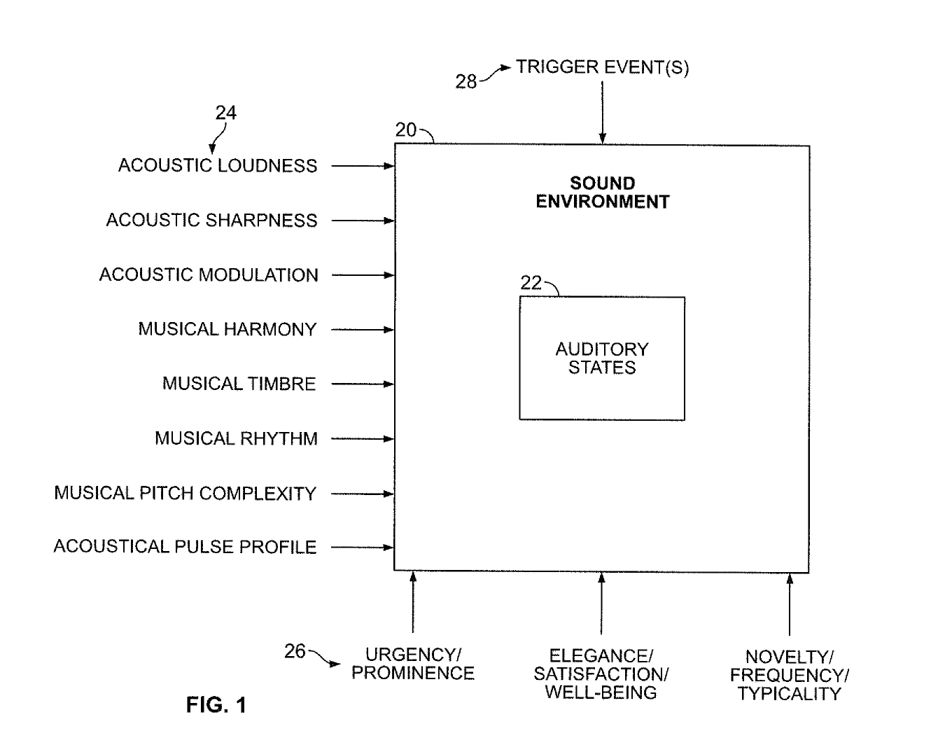

In particular, various embodiments allow for management of an auditory messaging environment, such as in a clinical setting. In one embodiment, a sound environment 20 (e.g., in a hospital room) may be provided as shown in FIG. 1. For example, the sound environment 20 may be a continuous sound environment in a clinical setting that incorporates multiple auditory states 22 representing different medical messages and/or conditions from one or more medical devices. In one embodiment, the sound environment 20 may be defined or described by various levels corresponding to different sound metric descriptors 24. For example, the sound metric descriptors may include, but are not limited to, the following:

Acoustic Loudness;

Acoustic Sharpness;

Acoustic Modulation (e.g., present or absent in 20 Hz to 200 Hz range);

Musical harmony (harmonious vs. discordant);

Musical timbre (natural/classical vs. artificial/mechanical);

Musical rhythm (complex/rhythmic vs. simple/irregular);

Musical pitch complexity (constant pitch vs. variable pitch); and/or

Acoustical pulse profile.

It should be appreciated that the sound environment may be a continuous sound environment wherein one state is designated as a continuously playing background with other states representing different medical auditory messages. However, in other embodiments, a continuously playing background is not provided.

The sound environment 20 also may be defined or described by one or more psychological descriptors 26. For example, the psychological descriptors 26 may include, but are not limited to, the following:

Urgency/Prominence;

Elegance/Satisfaction/Well-Being; and/or

Novelty/Frequency/Typicality.

However, other descriptors may be used as desired or needed.

In accordance with various embodiments, a functional relationship is defined that links psychological sound perceptions in clinical environments to acoustic and musical sound variable (metrics and settings) to manage the sound environment 20. For example, in the illustrated embodiment, one or more trigger events 28, such as detected medical events (e.g., detected patient condition by a monitoring device) trigger specific different medical auditory messages in the sound environment 20 that are defined or designated based on one or more of the sound metric descriptors 24 and one or more of the psychological descriptors 26. Additionally, in some embodiments, the continuous sound environment parameters may be adjusted, such as based on the trigger event(s) 28, to represent different auditory messages and/or conditions. The defined auditory signals may be stored, for example, in a database that is accessible, with a particular auditory signal selected or generation and outputting based on the trigger event(s) 28.

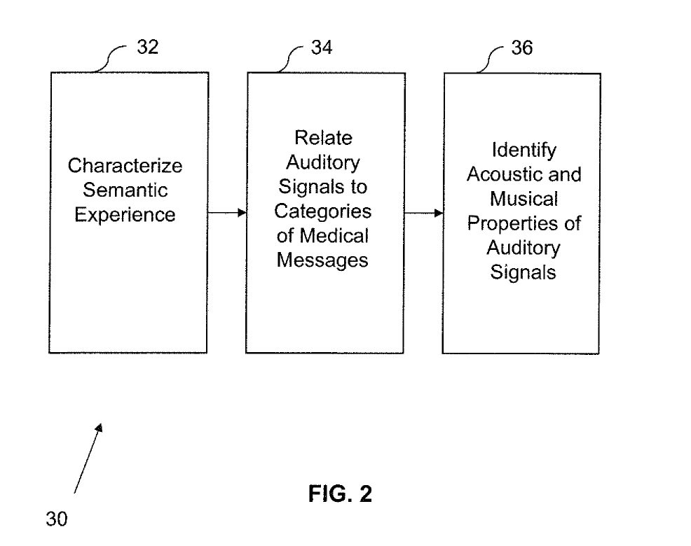

In various embodiments, one or more auditory device signals and/or medical messages are generated based on a common semantic experience, for example, by quantifying a nurses' semantic experience of auditory device signals. Using correlated acoustic and musical properties of auditory signals to semantic experiences provides design guidance as described in more detail herein. One embodiment of an auditory device signal and/or medical message process or design flow 30 is illustrated in FIG. 2. In the illustrated embodiment, the flow 30 includes characterizing a semantic experience of auditory device signals and/or medical messages at 32. For example, nurses' semantic experience of auditory device signals and/or medical messages are characterized, which in one embodiment includes using only auditory signals. The flow 30 also includes at 34 relating the auditory signals and/or medical messages based upon a common semantic experience, such as determined from the characterization at 32. The flow 30 additionally includes identifying acoustic and musical properties of auditory signals at 36 that are correlated with the dimensions of the semantic experience. The steps of the flow 30 are described in more detail herein.

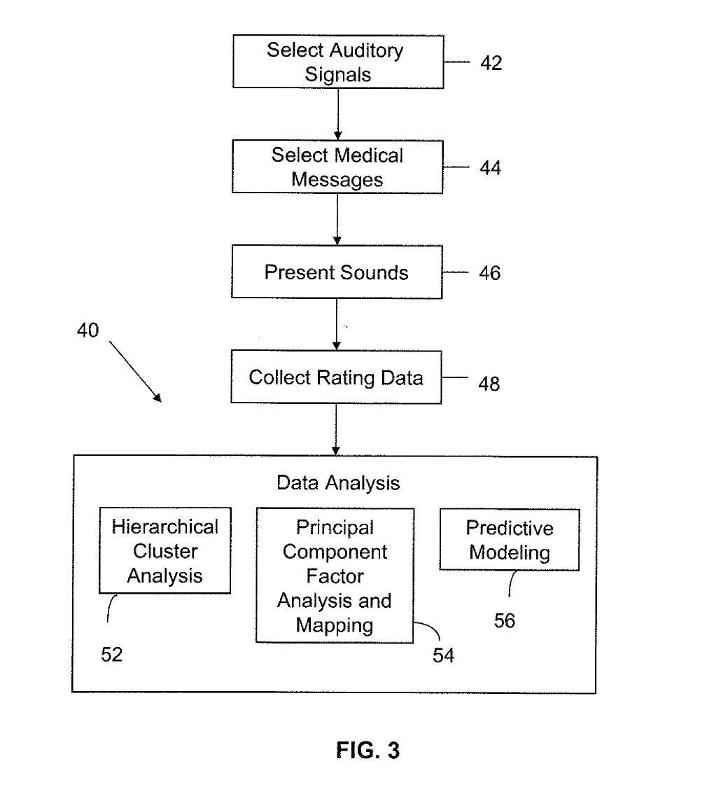

A method 40 for use in generating auditory device signals and/or medical messages is shown in FIG. 3. The method includes selecting a plurality of sample or base auditory signals for evaluation at 42. For example, thirty auditory signals may be selected for evaluation, such as by a plurality of nurses. The auditory signals may correspond to different conditions or standards, such as different IEC alarm standards for different urgency levels (e.g., low, medium and high urgency levels). The auditory signals may be, for example, IEC low, medium and high urgency alarm melodies with varying musical properties of timbre, attack and decay. Additionally, in some embodiments, different non-standard, arbitrary or random auditory signals may be selected, such as generated by a professional sound engineer.

The method 40 also includes selecting a plurality of medical messages at 44. For example, thirty medical messages may be selected, such as medical messages typically indicated using auditory signals and that are sampled from documentation of devices of interest, such as documentation for ventilators, monitors and infusion pumps. However, depending on the particular application, medical messages for different devices may be selected. In various embodiments, medical messages include messages associated with low, medium and high criticality patient conditions may be sampled, as well as device information/feedback messages.

Sounds corresponding to the selected auditory signals may then be played at 46. For example, the selected auditory sounds may be presented to a study group for evaluation. The method 40 then includes collecting rating data at 48, such as using an online survey tool (e.g., Survey Gizmo) to collect the rating data. For example, one or more rating scales may be used, which in one embodiment includes eighteen bipolar attribute rating scales having word pairs intended to capture semantic dimensions, which in some embodiments includes three semantic dimensions of Evaluation, Potency and Activity, plus the additional dimension of Novelty. In various embodiments, the principal attribute of alarm quality/urgency also includes one pole of a bipolar rating scale. Additional attributes may include, for example, brand language attributes (e.g., GE Global Design brand language attributes). In one embodiment, eighteen attribute pairs may be used as shown in Table 1 below.

TABLE 1

| Reference Source | Bipolar Attribute Rating Pairs | |
|---|---|---|
| Company Brand | Precise | Vague |
| Company Brand | Trustworthy | Unreliable |
| Company Brand | Healthy | Sick |
| Company Brand/SD | Harmonious | Discordant |
| Evaluation | | |
| Company Brand/SD | Elegant | Unpolished |
| Evaluation | | |
| SD Evaluation | Satisfying | Dissatisfying |
| SD Evaluation | Reassuring | Disturbing |
| SD Potency | Delicate | Strong |
| SD Potency | Yielding | Firm |
| SD Potency | Submissive | Assertive |
| SD Intensity | Distinct | Indistinct |
| SD Intensity | Tense | Relaxed |
| SD Intensity | Agitated | Calm |
| SD Intensity/IEC | Urgent | Unimportant |
| Standards | | |
| Company Brand/Novelty | Imaginative | Ordinary |
| SD Novelty | Unusual | Typical |
| SD Novelty | Rare | Frequent |
| SD Novelty | Unexpected | Common |

In one embodiment, a seven-point rating scale may be created from the attribute pair, such as illustrated in Table 1. It should be noted that the polarity of the attribute pairs (left vs. right) may be randomized, as well as the sequential order in which the rating scales appear. Also, the same format is retained across each item that is rated. Additionally, a verbal anchor is placed above each of the seven rating points to indicate the degree of association of each rating point with the corresponding attributes in each pair (e.g., Extremely, Quite, Slightly, No Opinion, Slightly, Quite, Extremely for each pair and an anchor statement such as “Expired air volume is too high”). However, it should be noted that different types and arrangements of rating scales may be used.

Thus, in one embodiment, the sequential order of the thirty auditory signals and thirty medical messages may be randomized and divided into four approximately equal-size subgroups. Four unique orderings of each list of items may then be created by rearranging the subgroups according to a Latin Square arrangement. The sequential order of individual items within each subgroup may be reversed for two of the four lists of auditory signals and medical messages, thus balancing for order effects within each subgroup. Each auditory signal and each medical message appears equally as often across participants in the first, second, third and fourth quarter of the presentation sequence and equally as often before and after each other item within the subgroup.

The data collected at 48 may be collected, for example, from small groups, such as groups of four or five participants. The information for evaluation may be presented to each participant via a laptop computer on which to view, for example, an online survey. In some embodiments, auditory signals and medical messages may be presented in separate blocks that are counterbalanced such that approximately half of the participants in the study receive auditory messages first. The participants may begin each rating session by reading an instruction sheet. In one embodiment, all participants in a group are allowed to complete ratings of a given auditory signal before the next auditory signal is presented. It should be noted that ratings for medical messages may be self-paced because the message can be presented at the top of a page on which the rating scales appear in the survey.

In various embodiments, different measures may be used. For example, each auditory signal and each medical message may be rated on each of a plurality (eighteen in the illustrated example) bipolar attribute rating scales by each of a plurality of participants. As one example, values ranging from −3 (the left-most point on each the rating scale) to +3 (the right-most point) may be used. The resulting data set includes 2,340 rows with a column for each of the eighteen bipolar attribute scales.

Each auditory signal may be independently measured on a plurality of (e.g., fifty three) acoustic metrics divided into two categories: Objective Acoustic (36) and Pulse/Burst Attributes (17). For example, the Objective Acoustic metrics may be measured by a suitable method or package, such as using the Artemis acoustics software package available from HEAD Acoustics. It should be noted that some metrics reflect observed patterns in Level (dB(A)) plotted over the time course of the auditory signals. For example, Pulse/Burst Attributes reflect patterns observed in Level (dB(A)) plotted over the time course of the auditory signal for individual pulses. It also should be noted that a subset of auditory signals may be used that replicate IEC standards, or may use IEC melodies with variations of musical attributes such as timbre, chord structure, attack and decay. These different patterns may be coded categorically and treated as independent variables in the analysis as described in more detail below.

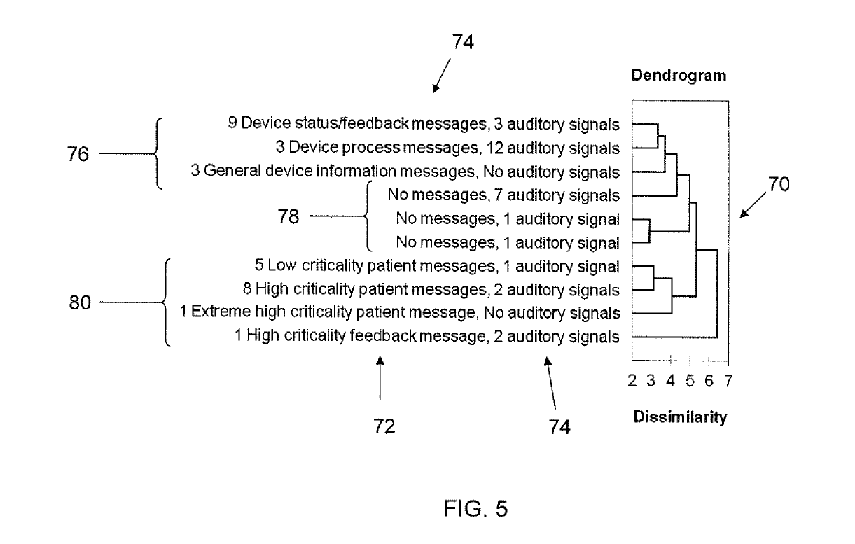

The method 40 also includes performing data analysis at 50 (with one or more processors or modules) using the collected rating data to identify or select different characteristics or properties for one or more auditory device signals for medical messaging. For example, various embodiments provide semantic, acoustic and musical analysis as part of step 50 for generating auditory device signals for medical messaging. In particular, the analysis at 50 includes in some embodiments a hierarchical cluster analysis at 52. For example, in one embodiment, bipolar attribute ratings are averaged across participants for each auditory signal and each medical message. A data file then may be created in which columns corresponded to individual bipolar attributes and rows corresponded to individual auditory signals and medical messages experienced by each participant. The data may be processed, for example, with a hierarchical cluster analysis using a suitable method or program, such as XLSTAT (available from Addinsoft), and in which an Un-weighted Pair-group Average agglomeration method is used. It should be noted that the auditory signals and the medical messages may be clustered simultaneously using the cluster analysis of the rating data. For example, the dendrogram 70 in FIG. 5, described below, illustrates both auditory and medical messages clustered together.

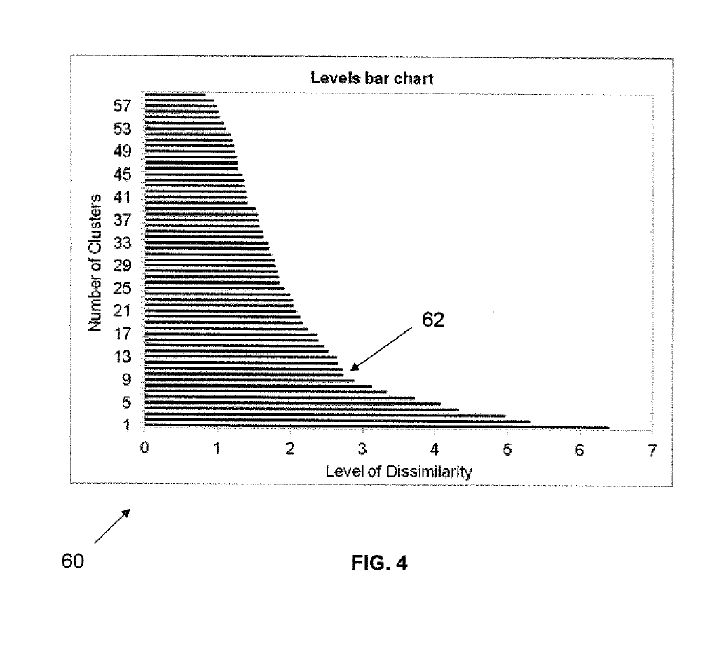

FIG. 4 illustrates a levels bar chart 60 for the cluster analysis, which plots the distances at which clusters are joined at each stage of the clustering process. It should be noted that an elbow is apparent at the ten-cluster solution point 52 (i.e., the dissimilarity grows larger at a ten cluster solution) indicating that in this example, ten clusters may provide the optimal grouping of auditory signals and medical messages. In the chart 60, the vertical axis represents numbers of clusters and the horizontal axis represents the dissimilarity at which clusters joined. Accordingly, in one embodiment, a ten cluster solution is used such that ten message/quality attributes are defined, which as described in more detail herein may include seven medical messages and three unassigned messages.

In various embodiments, a dendrogram may be used to show the links among items joined at each stage of the clustering process. For example, FIG. 5 illustrates a dendrogram 70 showing the top-most linkages among clusters, and a summary of the contents of each cluster. It should be noted that the three clusters at the top of the dendrogram 70 contain messages that are related to device conditions. The four clusters at the bottom of the dendrogram 70 contain messages that are related to patient-critical conditions, or feedback that could impact patient safety. The three clusters in the middle of the dendrogram 70 contain auditory signals that are not associated with any medical messages. Two of these clusters are defined by a single unique auditory signal. Thus, the results of the cluster analysis in the illustrated example suggest that nurses in the ICU environment conceive of seven semantically distinct categories of medical messages with five of the clusters of medical messages containing auditory signals, which, because of the semantic similarity to messages, convey an inherently similar meaning regarding the category of messages.

Thus, the dendrogram 70 generally shows the counts or tallies of messages 72 and sounds 72 within each cluster 74. As can be seen, the clusters 74 are divided into groups. In particular, the clusters 74 in the illustrated dendrogram 70 are divided into three major groups: group 76, which are device conditions; group 78, which are sounds that are not associated with any messages; and group 80, which are patient conditions. It should be noted that two clusters of medical messages contain no associated sounds (namely low-priority device info and extremely high-urgency patient message), which may be used to provide new device auditory signals.

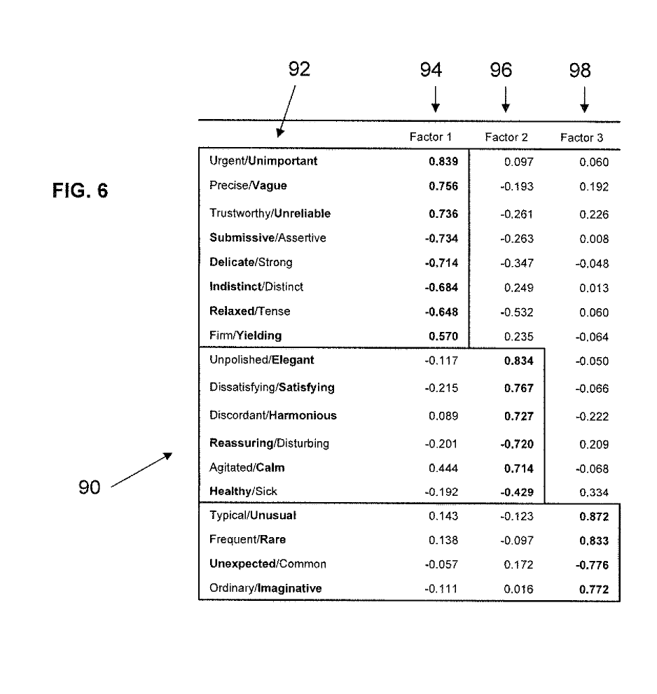

Referring again to FIG. 3, the data analysis at 50 also may include a principal component analysis and mapping at 54. In particular, in one embodiment, bipolar attribute rating data for auditory signals may be processed using a Principal Components Factor Analysis, such as with a suitable program (e.g., XLSTAT available from Addinsoft 2012). In one example, Eigen values exceeded the critical value of 1.00 for the three-factor solution, which explains the 62.40% of the variance in ratings. FIG. 6 shows a table 90 of factor loading values for each bipolar attribute pair on each of the three factors in this example. The bipolar attributes are sorted and grouped according to the factor on which that factor was most heavily loaded. Because the polarity of attributes was randomized for data collection in this example, it should be noted that factor loadings are sometimes negative indicating that the left-most attribute in the pair is associated with positive values on the factor. The attributes associated with positive factor scores are indicated in bold text. Thus, in the table 90, the column 92 includes the eighteen word pairs that span or encompass a range of semantic content. The columns 94, 96 and 98 are factors (F) that correspond to a set of sound quality differentiating scales that describe the medical auditory design space.

As can be seen, the attribute with the largest loading on Factor 1 is Urgent, which is the primary attribute for alarm quality. Other attributes associated with this factor are Precise, Trustworthy, Assertive, Strong, Distinct, Tense and Firm. The common underlying concept expressed by these attributes is intensity or distinctiveness of auditory signals. The attribute loading highest on Factor 2 is Elegant. Other attributes with high loadings on Factor 2 are Satisfying, Harmonious, Reassuring, Calm and Healthy. The common underlying concept expressed by these attributes is Satisfaction and Well-being. The attribute loading highest on Factor 3 is Unusual followed by Rare, Unexpected and Imaginative. The common underlying concept expressed by these attributes is novelty or low frequency of occurrence.

In one embodiment, the Factor Analysis program calculates a single summary score for each item in the analysis on each of the three factors. Factor scores for auditory signals are averaged across participants for each auditory signal producing a single summary score for each. It should be noted that the factor scores for Factor 1 are repolarized such that the attribute of Urgent was associated with positive factor scores.

The method 40 also includes at 54 mapping Objective Acoustic Metrics and Musical Attributes to the three-factor perceptual space produced by the Factor Analysis, which may be performed using a suitable method or program, such as a Prefmap application of XLSTAT (available from Addinsoft). It should be noted that in one embodiment a separate Prefmap Multiple Regression analysis is conducted for each Objective Acoustic Metric and Musical Attribute using mean factor scores for each of the three factors as predictor variables. In one embodiment, analyses are organized into three groups: a) Objective Acoustic Metrics, b) Musical Attributes and c) Pulse/Burst Attributes. Because of the large number of analyses (and the statistical probability of finding significant results by chance alone), a strict statistical criterion for acceptance is chosen in one embodiment that consists of: a) a p value less than 0.01 and b) a multiple R greater than 0.600. Using these criteria, in the illustrated embodiment, fourteen analyses spanning all three categories of acoustic metrics and musical attributes may be determined as significant.

One particular example and application of the various embodiments will now be described with reference to the exemplary results shown in FIGS. 4-6 to illustrate the use of the various embodiments in generating auditory medical device signals. Using the various embodiments, results of the cluster analysis in the example indicate that ICU nurses conceive of seven semantically distinct categories of medical messages. In particular, four categories relate to patient-critical conditions: a) low-criticality patient messages, b) high-criticality patient messages, c) a unique high-criticality patient message and d) a high-criticality feedback message (alarm cancelled). Three of the four clusters also contained auditory signals, which, because of a shared semantic meaning with messages, are excellent candidates for communicating those messages in medical devices. Consistent with this fact, a current IEC low-priority alarm standard is clustered with low-criticality patient messages validating the effectiveness for communicating this class of messages. Similarly, a current IEC high-priority alarm standard is clustered with high-criticality patient messages. A company alarm, which in this embodiment is a GE Unity Alarm is also clustered with these patient messages validating the effectiveness for communicating high-criticality patient messages. Two non-standard auditory signals are clustered with the unique message, “high-urgency alarm turned off”. Similarly, a fourth cluster contained the single patient message, “patient disconnected from ventilator”, which has no associated auditory signals

Three clusters contain messages related to device status/feedback: a) low priority feedback, b) common device alerts/feedback and d) process/therapy status. Current standards call for an informational auditory signal that is distinct from alarms. Thus, based on the results in the illustrated example, a single informational signal is not sufficient to capture the conceptual distinctions nurses have of device-related medical messages. One category of device message (i.e., low-priority alerts/feedback) appears to correspond to the informational message specified in the standards. Using results from various embodiments provides for design guidance for acoustic and musical properties appropriate for conveying this type of message. The other two clusters of device messages do not contain auditory signals, which provide design options to fill gaps for those types of messages.

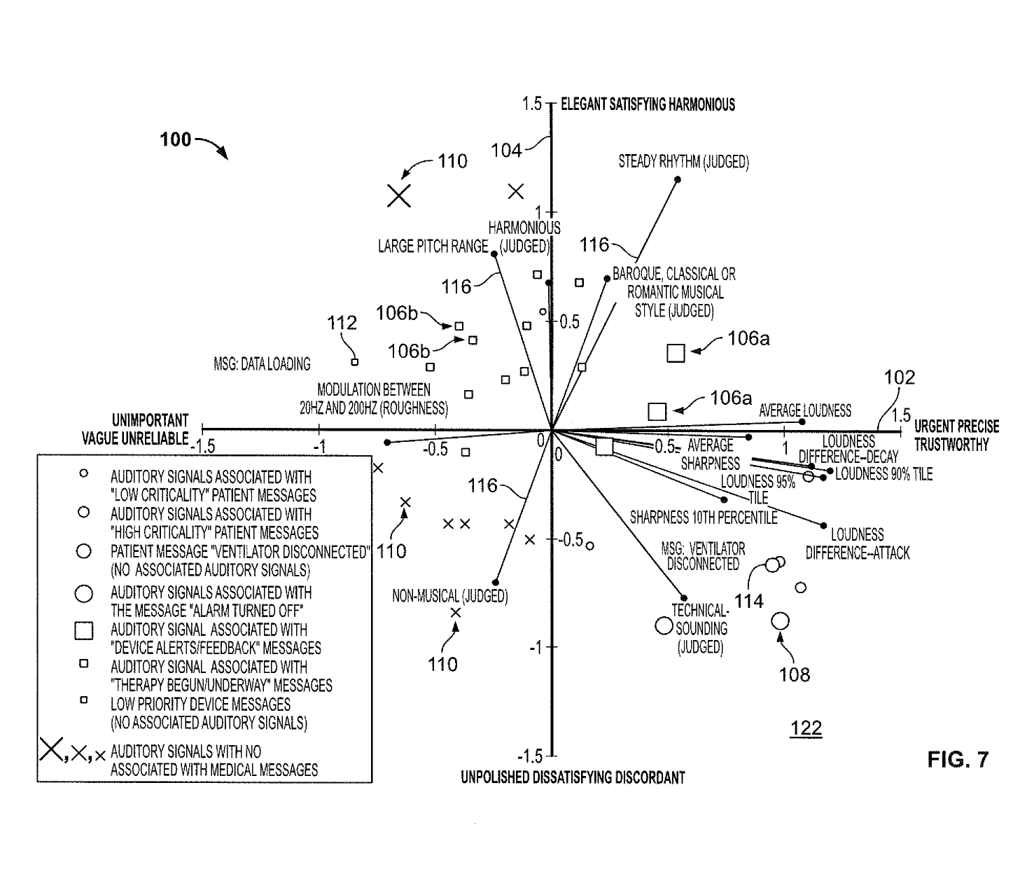

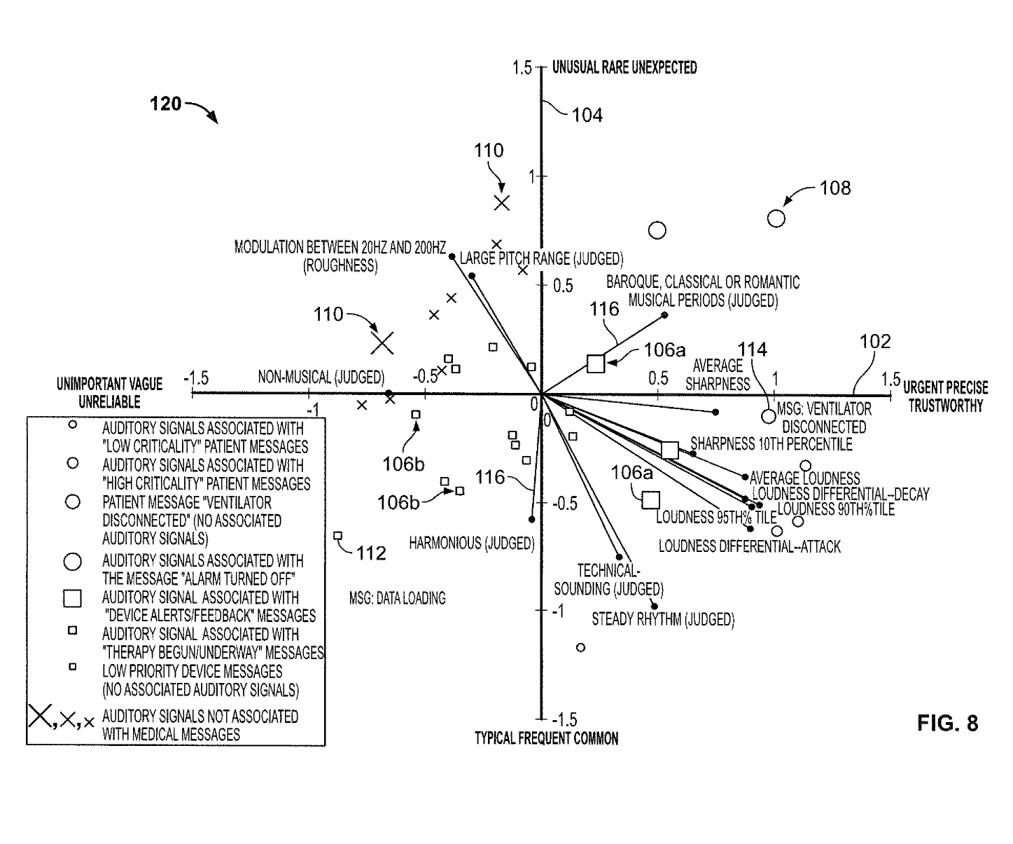

With respect to the Principal Components Factor Analysis and mapping scores, the factor scores generated by the factor analysis may be used to plot each of the thirty auditory signals in a 3-dimensional semantic space. The three dimensions may be represented in two 2-dimensional scatter plots. FIG. 7 shows data points for the thirty auditory signals plotted on a scatter plot 100 as a function of the first two semantic factors (Factors 1 and 2) and FIG. 8 shows data points for the thirty auditory signals plotted on a scatter plot 120 as a function of the first and third semantic factors (Factors 1 and 3). However, other plots or graphs may be used. The rating attributes that loaded highest on each factor are shown at the ends of the axes 102, 104 with which the attributes were associated. The symbols for data points are coded to indicate cluster membership from the Cluster Analysis. In particular, the square symbols 106 indicate clusters associated with device messages, circular symbols 108 indicate clusters associated with patient-critical messages and X's 110 indicate clusters of auditory signals that were not associated with any medical messages. The differences among clusters within each of these three major categories are indicated by different sized symbols. Two additional data points (one square 112 and one circle 114) indicate the positions of the class centroid message from each of the two clusters that had no associated auditory signals. These data points characterize the semantic quality of the medical messages in each cluster and provide a semantic design goal for auditory signals intended to communicate those messages. The coordinates for these representative data point may be obtained by performing a second Factor Analysis, in which the raw ratings for these two messages are included among the ratings for the thirty auditory signals, thus generating factors scores for each in the 3D semantic space.

Vectors 116 for objective acoustic metrics and musical attributes that meet statistical criteria for correlation with the three semantic factors are overlaid on the scatter plot 100 using, for example, the Prefmap application. The length of each vector 116 indicates the degree of correlation between the metric/attribute and the data points in the semantic space. Data points nearest the endpoint of each vector 116 have the greatest amount of the metric/attribute indicated by that vector 116. The degree of alignment of each vector 116 with individual axes 102, 104 indicates the degree of correlation of that metric/attribute with the semantic attributes represented by the axes 102, 104. It should be noted that vectors 116 should be assumed to extend equally in the opposite direction to indicate low values for the metric/attribute represented.

Considering the scatter plot 100 of FIG. 7, all auditory signals associated with patient-critical messages are positioned in the lower-right quadrant 122 of the scatter plot 100 indicating a generally Urgent and Unpolished semantic quality. The association of these auditory signals with the semantic quality of being Urgent is consistent with the fact that perceived Urgency is considered to be a key attribute of alarm quality in the example described herein. The most urgent auditory signals positioned nearest the right end of the horizontal axis 102 are associated with the most critical patient messages. Included among these signals are an auditory signal for an IEC high-urgency alarm standard and the current GE Unity high-urgency alarm, confirming the effectiveness of these auditory signals for communicating high-criticality patient messages. Also positioned at the far right of the scatter plot 100 is the data point representing the patient message “ventilator disconnected” for which there were no associated auditory signals. This data point is not well differentiated from the other high-urgency alarms in this scatterplot 100.

Property vectors 116 aligned with the horizontal axis 102 indicate that the Urgent auditory signals have high levels of the objective acoustic metrics related to Loudness and Sharpness including a large difference in Loudness across the attack and decay phases of individual pulses. This suggests that perceived urgency is mediated by the prominence and distinctiveness of auditory signals. Perceived Urgency is also associated with low levels of Roughness, the absence of which might improve the apparent clarity of the auditory signals.

The auditory signal associated with low-criticality patient messages (a current IEC low-urgency alarm standard) is positioned nearest the middle of the scatterplot 100 consistent with the lower level of perceived Urgency. The two auditory signals associated with the feedback message “high-urgency alarm has been turned off” are positioned nearest the bottom of the spatial configuration indicating that these messages have an Unpolished (Dissatisfying, Discordant) semantic quality. The property vectors 116 aligned with the vertical axis 104 indicate that this semantic quality is associated with the musical attributes of having non-steady rhythm, small pitch range, non-musical timbre and being harmonically discordant. This pattern indicates that in addition to differences in apparent urgency, nurses also attend to differences in the disturbing quality of messages and auditory signals. Disengaging a high-urgency alarm is particularly disturbing even in the context of other patient-critical messages.

Auditory signals associated with device messages are semantically more Elegant and Satisfying than patient-critical messages and span the lower range of Urgency. The most urgent of the device messages (the largest squares 106a) are associated with device alerts and feedback confirming that these messages require attention, but less so than the most patient-critical messages. Auditory signals associated with therapy delivery (medium squares 106b) are neutral to moderately Unimportant. The class centroid message “data loading” is semantically the most Unimportant (least urgent) data point. Although there is no auditory signal associated with this category of message, an auditory signal appropriate for this category would be acoustically soft with comparatively low levels of Loudness and Sharpness, soft attack and long decay, and would also have higher levels of Roughness.

Finally, auditory signals that are not associated with medical messages are semantically somewhat Unimportant and either extremely Elegant (musical) or extremely Unpolished (not-musical). These semantic qualities would not be effective for communicating medical messages

The scatter plot 120 of FIG. 8 shows Factor 1 plotted once more on the horizontal axis 102 with Factor 3 plotted on the vertical axis 106. Is should be noted that the auditory signals for patient-critical messages are now well differentiated along the vertical axis. The IEC low-criticality alarm is positioned at the extreme bottom of the axis 104 consistent with the high frequency of occurrence in typical ICU environments. Somewhat less Typical are the auditory signals associated with high-criticality patient messages. The patient message “ventilator disconnected”, for which there is no auditory signal, is now differentiated from the other high-criticality patient messages by being somewhat less typical. The two auditory signals for the patient message “high-urgency alarm has been turned off” are positioned nearest the upper pole of the vertical axis 104 indicating that these signals are the most Unusual (least Typical) auditory signals. This pattern of differentiation among patient-critical messages indicates that the frequency of occurrence of medical conditions associated with patient messages is important to nurses and should be reflected in the perceptual qualities of the auditory signals used to indicate them. Given that the Typicality of messages changes over time, identifying a fixed acoustical or musical property associated with such a message may be difficult. It should be noted that the regression weights from the multiple regression analysis showed that large weights on Factor 3 were obtained for the variables Roughness, Technical sounding and Steady Rhythm. The most Unusual sounds were Rough and did not have a technical sound or steady rhythmic qualities.

Referring again to the method 40 of FIG. 3, the data analysis at 50 also may include predictive modeling at 56. For example, in one embodiment, Multiple Regression is used to predict acoustic metrics and musical attributes based upon coordinates in the 3D semantic space. A separate model then may be created for each acoustic metric and musical attribute that was mapped to the 3D semantic space, such as by PrefMap. Several of the predicted acoustic or musical variables may be coded categorically (present=1, absent=0) and the predicted values then range between these extremes. The predicted values near one of the extremes provide directional guidance for designing auditory signals targeted at a specific semantic character.

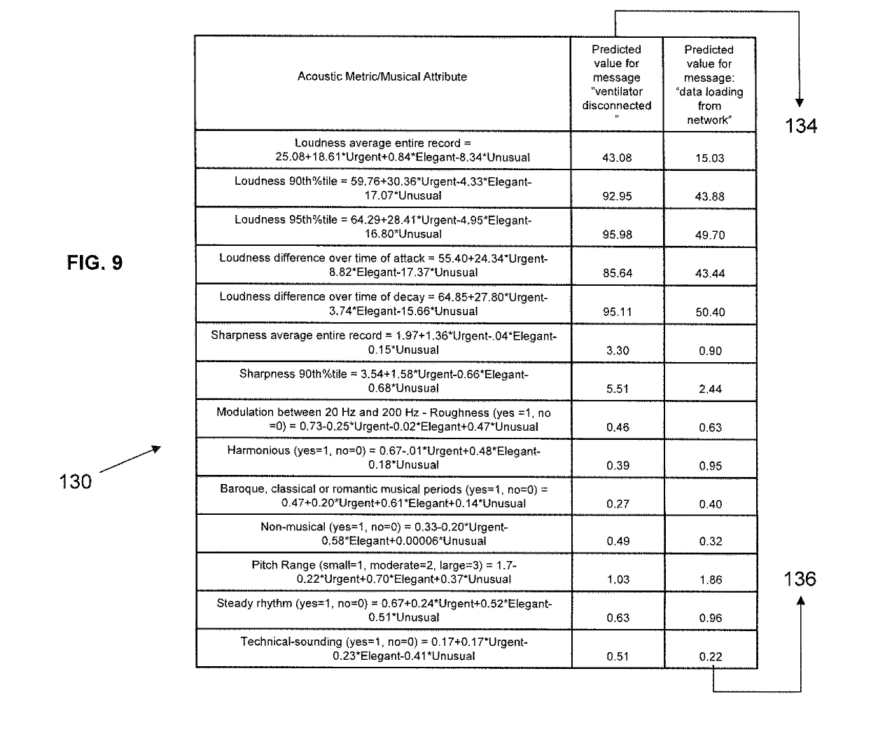

Continuing with the example described above, two clusters of medical messages have no associated auditory signals and these provide candidates for modeling acoustic and musical properties for auditory signals to communicate medical messages in these categories. Coordinates for the centroid message in each of these clusters (plotted in the 2D scatterplots 100 and 120 discussed above) provide inputs to the models for predicting acoustic and musical properties for appropriate auditory signals. The regression models used to predict these values, and the resultant values, are shown in the table 130 of FIG. 9 for each of the two centroid messages. In the table 130, the column 132 corresponds to the acoustic metric or musical attribute, the column 134 corresponds to the predicted value for one message (illustrated as “ventilator disconnected”), and the column 136 corresponds to the predicted value for another message (illustrated as “data loading from network”).

It should be noted that the predicted values for Loudness, Sharpness, Attack and Decay are considerably larger for the message “ventilator disconnected” (a high-criticality patient condition) than for “data loading” a comparatively low-criticality device message. Also, the values for categorically coded variables suggest a somewhat more Harmonious, Rhythmic and diverse pitch range for the “data loading” message. The predicted values for other categorical variables are in the moderate range for both types of message indicating that neutral values should be chosen for these metrics.

Thus, various embodiments may be used to design or generate auditory signals, such as auditory medical messages. In the described example, Intensive Care Unit nurses are shown to have a complex conceptualization of medical messages that included four categories of patient-critical messages and three categories of device messages. However, it should be appreciated that using various embodiments, different categories may be analyzed as desired or needed.

The medical messages used in the described example spanned four levels of priority as defined by current standards (IEC International Standard 60601-1-8): low, medium and high priority alarms, plus technical messages. The clustering of messages into seven semantically distinct categories in the illustrated example suggests a richer conceptualization of medical messages than is accounted for by this framework. Whereas nurses conceive of several categories of messages that are not accounted for in current standards, the nurses also fail to distinguish between some categories of messages that are specified in standards. Specifically, nurses distinguished between low- and high-criticality patient messages respectively, which were correctly associated with auditory signals representing current IEC low- and high-urgency alarms. However, nurses did not conceive of a medium criticality category of patient messages between these two. Instead, the nurses conceived of a cluster of low-priority technical messages related to device alerts/feedback, e.g., “Transmitter cable is off”. No auditory signals were associated with this category of technical messages in the illustrated example, but design guidance for creating a semantically similar auditory signal may be provided by the predictive models that correlate acoustic and musical properties with the semantic profile for this type of message. Such an auditory signal would be as Urgent (Loud and Sharp) as a low-priority alarm, but semantically more Elegant (musical) and much more Unusual (natural and rough) than the Tow-priority alarm.

There were two additional categories of patient messages that are not specified in current standards in the illustrated example. One message corresponded to a high-criticality, but rare, patient message, “Patient is disconnected from the ventilator”. The fact that infrequent messages are conceived to be distinct from other more typical messages indicates that this property, in addition to criticality, is an important attribute to communicate via auditory signals for medical messages. No auditory signals were associated with this unique message. However, predictive models that correlate acoustic and musical properties with the three semantic qualities provide design guidance that may be used for creating one in accordance with various embodiments. An auditory signal for this message would be as Loud, Sharp and unmusical as the IEC high-priority alarm, but would have more Roughness and a more natural timbre.

In the illustrated example, there is also a gap for a fourth type of patient-critical message providing feedback that a high-urgency alarm has been disabled. Like other high-criticality patient messages, the semantic profile for this message was highly Urgent (Loud and Sharp) and Unpolished (unmusical). However, the message was also highly Unusual, which was associated with the acoustical property of being Rough and the musical property of having natural timbre.

In addition the above described technical alarm indicating device conditions, there was also a category of low-priority device alerts/feedback in the illustrated example, which appears related to informational messages specified in standards. There were no auditory signals associated with this category of messages. A design standard for informational messages was not included in the set of auditory signals described above, however, predictive models may provide design guidance for creating one.

Finally, there is a category of device messages related specifically to the status of therapy delivery or processes. This defines another gap in the standards in the illustrated example.

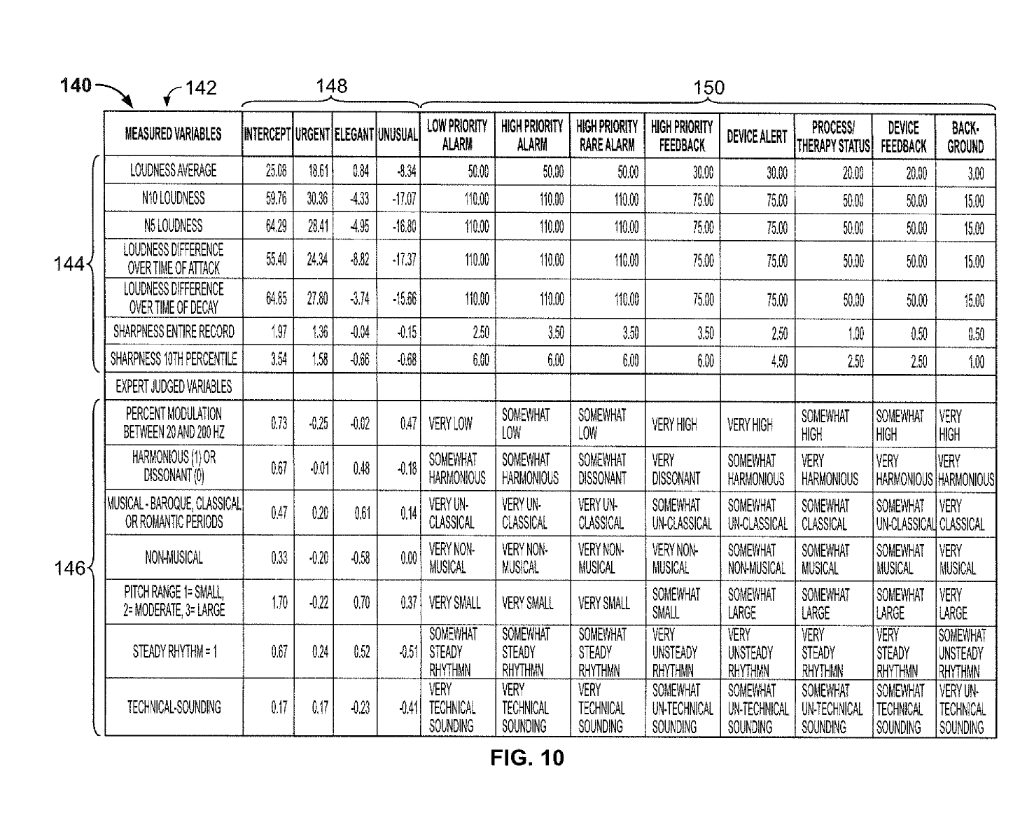

Continuing with the above example, a table 140 may be generated as shown in FIG. 10. The table 140 generally contains target values for the various metrics that were correlated with nurses' perceptions of auditory signals associated with various messages as described in more detail herein. Using the various embodiments, a pattern of values within a particular category or medical messages may be used to generate a corresponding auditory signal instead of the absolute values for each (although absolute values may be used in some embodiments). In the table 140, the values correspond to a loudness (or decibel (dB)) level. The variables 144 in column 142 correspond to measured variables (acoustic properties), which in the described example are based on rating data for nurses. The variables 146 in column 142 correspond to expert judged variables (musical properties), which in the illustrated example correspond to rating data for a professional musician.

The columns 148 correspond to the psychological variables, which in the described example are psychological measurements on perceived interception, urgency, elegance and unusualness. The values in columns 148 correspond to a statistical average of the ratings scales as described herein. The columns 150 correspond to target values for the various metric that were correlated with nurses' perceptions of auditory signals associated with various messages using various embodiments. The described example shows that the messages include low priority alarm, high priority alarm, high priority rare alarm, high priority feedback, device alert, process/therapy status, device feedback and background.

The target values, or actual determined values that may be generated using the various embodiments as described herein, may be used as design criteria for particular sounds based on perceptions. For example, a distinguishing property for each sound may be defined by the patterns of values in each of the columns 150, such as a change from a high value above 100 to a medium value between 50 and 100. Thus, for example, using the pattern of data (in the columns 150), a unique combination of all of the variables (in column 142) defines a particular sound, which for a medical application, may be an optimal sound corresponding to the medical message (corresponding to columns 150). For example, the loudness or sharpness for each of the auditory signals or sounds may be distinguished based on the values generated in accordance with various embodiments, which are statistical values of the correlation between the variable and the perception. It should be noted that the values in the table 140 are target or estimated values based on the example described herein. Accordingly, the table 140 illustrates values that are only one example of target values that may be used in generating or designing auditory signals as described herein. Accordingly, the values may be different based on the collected rating data and/or the particular application or message to be communicated. For example, in some embodiments, a range of values may be determined or defined by one or more embodiments. Moreover, as described in more detail herein, various embodiments use the pattern of values across the various metrics, e.g., high Loudness, moderate Harmony, and low Roughness. Thus, in various embodiments, point estimates (such as shown in the table 140 of FIG. 10) define relative differences that may be used identify or specify a given pattern.

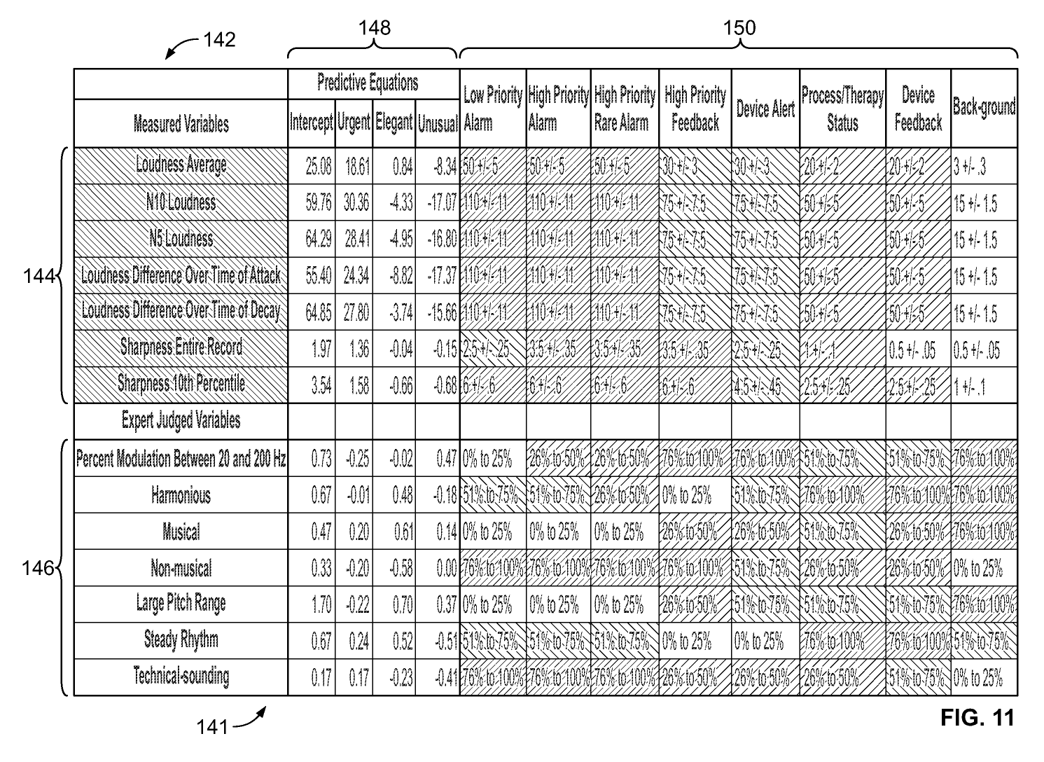

As another example, the values may be defined by ranges determined from the analysis or target values, such as illustrated in the table 141 shown in FIG. 11. For example, with respect to the exemplary values for the variables 144, a range of value may be used that are +/−10% of the values illustrated. However, other ranges may be used, for example, +/−5%, +/−20% or +/−25%, among other ranges as desired or needed. Also, with respect to the variables 146, the correlation or analysis the example were based on rating data of 1 or 0. However, in other embodiments, different granularities of values may be used, such as 0.5, 0.25 or 0.1 (illustrated as percentages in FIG. 11), among others as desired or needed. It should, thus, be appreciated that in some embodiments, different ranges of values may be used or result from the analysis.

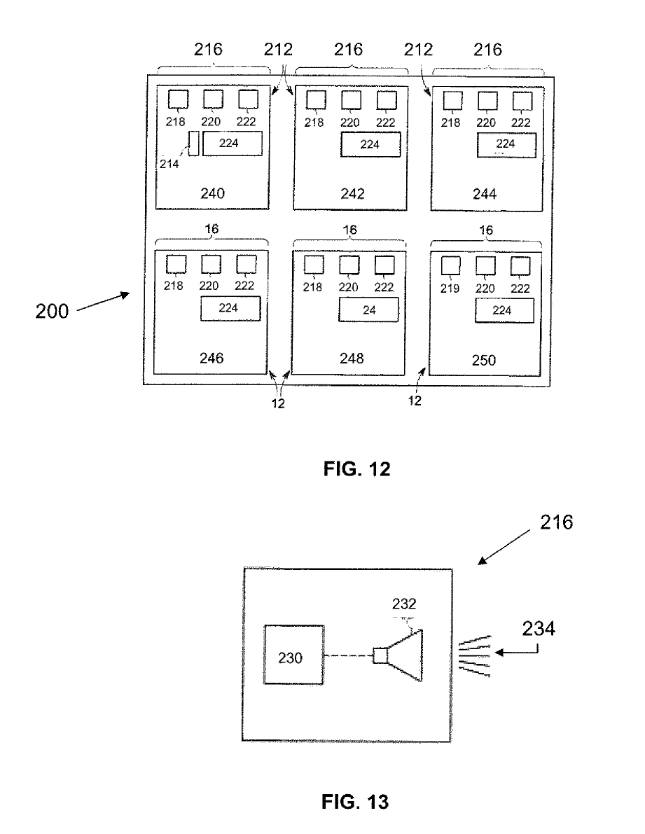

The various embodiments may be used to generate auditory sounds for a healthcare facility. For example, FIG. 12 is a block diagram of an exemplary healthcare facility 200 in which various embodiments may be implemented. The healthcare facility 200 may be a hospital, a clinic, an intensive care unit, an operating room, or any other type of facility for healthcare related applications, such as for example, a facility that is used to diagnose, monitor or treat a patient. Accordingly, the healthcare facility 200 may also be a doctor's office or a patient's home.

In the exemplary embodiment, the facility 200 includes at least one room 212, which are illustrated as a plurality of rooms 240, 242, 244, 246, 248, and 250. At least one of the rooms 212 may include different medical systems or devices, such as a medical imaging system 214 or one or more medical devices 216 (e.g., a life support system). The medical systems or devices may be, for example, any type of monitoring device, treatment delivery device or medical imaging device, among other devices. For example, different types of medical imaging devices or medical monitors include a Computed Tomography (CT) imaging system, an ultrasound imaging system, a Magnetic Resonance Imaging (MRI) system, a Single-Photon Emission Computed Tomography (SPECT) system, a Positron Emission Tomography (PET) system, an Electro-Cardiograph (ECG) system, an Electroencephalography (EEG) system, a ventilator, etc. It should be realized that the systems are not limited to the imaging and/or monitoring systems described above, but may be utilized with any medical device configured to emit a sound as an indication to an operator.

Thus, at least one of the rooms 212 may include a medical imaging device 214 and a plurality of medical devices 216. The medical devices 16 may include, for example, a heart monitor 218, a ventilator 220, anesthesia equipment 222, and/or a medical imaging table 224. It should be realized that the medical devices 216 described herein are exemplary only, and that the various embodiments described herein are not limited to the medical devices shown in FIG. 12, but may also include a variety of medical devices utilized in healthcare applications.

FIG. 13 is a simplified block diagram of the medical device 216 shown in FIG. 12. In the exemplary embodiment, the medical device 216 includes a processor 230 and a speaker 232. In operation, the processor 230 is configured to operate the speaker 232 to enable the speaker 232 to output an audible indication 234, which may be referred to as an audible message, such as an audible medical message, for example, an auditory alarm or warning. It should be noted that the processor 230 may be implemented in hardware, software, or a combination thereof. For example, the processor 230 may be implemented as, or performed, using tangible non-transitory computer readable medium. It should also be noted that the medical imaging systems 214 may include similar components.

In operation, the audible indications/messages generated by the medical imaging systems 214 and/or each medical device 216 creates an audible landscape (or sound landscape 20 shown in FIG. 1) using the various embodiments that enables a clinician to audibly identify which medical device 216 is generating the audible indication and/or message and/or the type of message (e.g., the severity of the message) without viewing the particular medical device 216. The clinician may then directly respond to the audible indication and/or message by visually observing the medical imaging system 214 or device 216 that is generating the audible indication without the need to observe, for example, several of the medical devices 16, if not desired.

In various embodiments, the audible indication 234, which may be a complex auditory indication, is semantically related to a particular medical message, such as corresponding to a specific medical alarm or warning, or to indicate movement of a piece of equipment, such as a scanning portion of the medical imaging system 214 as described in more detail herein. The audible indication 234 in various embodiments enables two or more medical systems or devices, such as the heart monitor 218 and the ventilator 220 to be concurrently monitored audibly by the operator, such that different alarms and/or warning sounds may be differentiated on the basis of acoustical and/or musical properties that convey a specific semantic character. Thus, the various audible indications 234 generated by the medical imaging system 214 and/or the various medical devices 216 provides a set of indications and/or messages that operate with each other to provide a soundscape for this particular environment. The set of sounds, which may include multiple audible indications 234, may be customized for a particular environment. For example, the audible indications 234 that produce the set of sounds for an operating room may be different than the audible indications 234 that produce the set of sounds for a monitoring room.

Additionally, the audible indications 234 may be utilized to inform a clinician that a medical device is being repositioned. For example, an audible indication 234 may indicate that the table of a medical imaging device is being repositioned. The audible indication 234 may indicate that a portable respiratory monitor is being repositioned, etc. In each case, the audible indication 234 generated for each piece of equipment may be differentiated to enable the clinician to audibly determine that either the table or the respiratory monitor, or some other medical device is being repositioned. Other medical devices that may generate a distinct audible indication 234 include, for example, a radiation detector, an x-ray tube, etc. Thus, each medical device 216 may be programmed to emit an audible indication/message based on an alarm condition, a warning condition, a status condition, or a movement of the medical device 216 or medical imaging system 14.

In various embodiments, the audible indication 234 is designed and/or generated based on different criteria, such as different acoustical and/or musical properties that convey a specific semantic character as described herein. In general, a set of medical messages or audible indications 234 that are desired to be broadcast to a clinician may be determined, for example, initially selected. In one embodiment, the audible indications 234 may be used to inform listeners that a particular medical condition exists and/or to inform the clinician that some action potentially needs to be performed. Thus, each audible indication 234 may include different elements or acoustical properties. For example, one of the acoustical properties enables the clinician to audibly identify the medical device generating the audible message and a different second acoustical property enables the clinician to identify the type of the audible alarm/warning, movement, or when any operator interaction is required. Moreover, other acoustical properties may communicate the medical condition (or patient status) to the clinician. For example, how the audible indication/message is broadcast, and the tone, frequency, and/or timbre of the audible indication may provide information regarding the severity of the alarm or warning, such as that a patient's heart is stopped, breathing has ceased, the imaging table is moving, etc.

In particular, various embodiments provide a conceptual framework and a perceptual framework for defining audible indications or messages. In some embodiments, sound profiles for medical images are defined that are used to generate the audible indications 234. The sound profiles map different audible messages to sounds corresponding to the audible indications 234, such as to indicate a particular condition or operation. For example, correlations between variables and perceptions as described herein may be used to define one or more auditory sounds. In one embodiment, an auditory message profile generation module may be provided to generate or identify different sounds profiles. The auditory message profile generation module may be implemented in hardware, software or a combination thereof, such as part of or in combination with the processor 230. However, in other embodiments, the auditory message profile generation module may be a separate processing machine wherein all of some of the methods of the various embodiments are performed entirely with one processor or different processors in different devices.

The auditory message profile generation module receives as an input defined message categories, which may correspond, for example, to medical alarms or indications. The auditory message profile generation module also receives as an input a plurality of defined quality differentiating scales. The inputs are based on a semantic rating scale as described in more detail herein and are processed or analyzed to define or generate a plurality of sound profiles that may be used to generate, for example, audible alarms or warnings. In various embodiments, the auditory message profile generation module uses at least one of a hierarchical cluster analysis or a principal components factor analysis to define or generate the plurality of sound profiles.

For example, various embodiments classify medical auditory messages into a plurality of categories, which may correspond to the conceptual model of clinicians working in ICU environments. In the various embodiments, a set of sound quality differentiating scales that describe the medical auditory design space are also defined. For example, seven different categories of medical auditory messages may be mapped to the four sound qualities differentiating scales to generate a plurality of sound profiles.

Thus, various embodiments may be used to generate unique sounds that denote medical messages/conditions and devices. Individual medical messages/conditions and individual devices are mapped to specific sounds via common semantic/verbal descriptors. The mapping leverages the complex nature of sounds having multiple perceptual impressions, connoted by words, as well as multiple physical properties. Certain properties of sounds are aligned with specific medical messages/conditions whereas other properties of sounds are aligned with different devices, and may be communicated concurrently, simultaneously or sequentially.

Various embodiments may define sounds that relate a particular medical message to a user. Specifically, descriptive words are used to relate or link medical messages to sounds. Various embodiments also may provide a set or list of sounds that relate the medical message to a sound. Additionally, various embodiments enable a medical device user to differentiate alarm/warning sounds on the basis of acoustical/musical properties of the sounds. Thus, the sounds convey specific semantic characteristics, as well as communicate patient and system status and position through auditory means.

It should be noted that the various embodiments, for example, the modules described herein, may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive, optical disk drive, solid state disk drive (e.g., flash drive of flash RAM) and the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), application specific integrated circuits (ASICs), logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software. Further, the software may be in the form of a collection of separate programs, a program module within a larger program or a portion of a program module or a non-transitory computer readable medium. The software also may include modular programming in the form of object-oriented programming. The processing of input data by the processing machine may be in response to user commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A medical system comprising:
at least one medical device configured to generate a plurality of medical messages; and
a processor in the at least one medical device configured to generate an auditory signal corresponding to one of the plurality of medical messages, wherein the auditory signal is configured based on a functional relationship linking psychological sound perceptions in a clinical environment to acoustic and musical sound variables.

2. The medical system of claim 1, wherein the functional relationship includes a domain of range of types of auditory messages defining at least eight unique categories.

3. The medical system of claim 1, wherein the linking is based on a pattern of values for a category of the plurality of medical messages, the values corresponding to metrics that correlate perceptions of nurses of the auditory signals with different types of medical messages.

4. The medical system of claim 1, wherein a plurality of auditory signals corresponding to the plurality of medical messages are defined by various levels of a plurality of sounds metrics, the sound metrics comprising acoustic loudness, acoustic sharpness, acoustic modulation, musical harmony, musical timbre, musical rhythm, musical pitch complexity and an acoustical pulse profile.

5. The medical system of claim 1, wherein the psychological sound perceptions comprise urgency/prominence, elegance/satisfaction/well-being and novelty/frequency/typicality.

6. The medical system of claim 1, wherein the acoustic and musical sound variables are correlated with a plurality of medical message categories.

7. The medical system of claim 1, wherein the linking is based on statistical averaging of one or more rating scales.

8. The medical system of claim 1, wherein for each of a plurality of auditory signals corresponding to a plurality of medical messages, a unique combination of values for the acoustic and musical sound variables define each of the auditory signals.

9. The medical system of claim 8, wherein the values comprise ranges of values for each of the variables.

10. The medical system of claim 8, wherein the values comprise target values for each of the variables.

11. A method for providing a medical sound environment, the method comprising:
defining a plurality of auditory states representing a plurality of different medical messages or conditions;
detecting one or more medical events and correlating the medical event to one of the medical messages or conditions;
triggering a medical auditory message corresponding to the detected medical event, wherein the medical auditory message is configured based on a functional relationship linking psychological sound perceptions in a clinical environment to acoustic and musical sound variables; and
outputting audibly the medical auditory message corresponding to the detected medical event.

12. The method of claim 11, further comprising providing a continuous sound environment in a clinical setting that incorporates the plurality of auditory states.

13. The method of claim 12, wherein one of the plurality of auditory states represents a designated continuously playing background and the other auditory states represent different medical auditory messages.

14. The method of claim 12, further comprising adjusting one or more continuous sound environment parameters to represent the different medical messages or conditions.

15. The method of claim 11, wherein the functional relationship includes a domain of range of types of auditory messages defining at least eight unique categories.

16. The method of claim 11, wherein the linking is based on a pattern of values for a category of the plurality of medical messages, the values corresponding to metrics that correlate perceptions of nurses of auditory signals with different types of medical messages.

17. The method of claim 11, wherein the output auditory message is defined by various levels of a plurality of sounds metrics, the sound metrics comprising acoustic loudness, acoustic sharpness, acoustic modulation, musical harmony, musical timbre, musical rhythm, musical pitch complexity and an acoustical pulse profile.

18. The method of claim 11, wherein the psychological sound perceptions comprise urgency/prominence, elegance/satisfaction/well-being and novelty/frequency/typicality.

19. The method of claim 11, wherein the linking is based on statistical averaging of one or more rating scales.

20. The method of claim 11, wherein for each of a plurality of auditory signals corresponding to the medical messages or conditions, a unique combination of values for the acoustic and musical sound variables define each of the auditory signals.

21. A non-transitory computer readable storage medium including a computer program for accessing a database, the computer program configured to:
access a plurality of defined auditory signals corresponding to one of a plurality of medical messages, wherein the auditory signals are defined in the database based on a functional relationship linking psychological sound perceptions in a clinical environment to acoustic and musical sound variables;
detecting a medical event and correlating the medical event to one of the medical messages; and
generating an auditory signal for the medical message correlated to the medical event and defined in the database.

22. The non-transitory computer readable storage medium of claim 21, wherein the plurality of defined auditory signals corresponding to the plurality of medical messages are defined by various levels of a plurality of sounds metrics, the sound metrics comprising acoustic loudness, acoustic sharpness, acoustic modulation, musical harmony, musical timbre, musical rhythm, musical pitch complexity and an acoustical pulse profile
